(19) United States
(12) Patent Application Publication
(10) Pub. No.: US 2016/0234364 A1
(43) Pub. Date: Aug. 11, 2016

(54) MOBILE PHONE / TABLET SHELL WITH FINGER GRASPING RING

(71) Applicants: DAVY ZIDE QIAN, ARCACIA, CA (US); BENYU QIAN, SHANGHAI (CN); LEQUN LU, SHANGHAI (CN)

(72) Inventors: DAVY ZIDE QIAN, ARCACIA, CA (US); BENYU QIAN, SHANGHAI (CN); LEQUN LU, SHANGHAI (CN)

(21) Appl. No.: 15/014,832

(22) Filed: Feb. 3, 2016

Related U.S. Application Data
(60) Provisional application No. 62/112,204, filed on Feb. 5, 2015.
(60) Provisional application No. 62/182,514, filed on Jun. 20, 2015.
(60) Provisional application No. 62/274,313, filed on Jan. 3, 2016.
(60) Provisional application No. 62/275,255, filed on Jan. 6, 2016.

(51) Int. Cl. H04M 1/02

(52) U.S. Cl. CPC H04M 1/0279

(57) ABSTRACT

A mobile phone/tablet shell with finger grasping ring comprises a box for receiving a body of the mobile phone or tablet, a finger grasping ring is provided on the box bottom; the finger grasping ring is provided a multiple of finger holes which are enterable by fingers; a turning connector connects the finger grasping ring with the box bottom, thereby the finger grasping ring is rotatable. The box is an elastic material, the finger grasping ring itself is a part of the box bottom, a part of surround of the finger grasping ring is divided from the box bottom and other part is still connected, the turning connector is an elastic connecting portion between the finger grasping ring and the box bottom.

### CROSS REFERENCE TO RELATED PATENT APPLICATION

The present application claims priorities of U.S. 62/112,204 filed Feb. 5, 2015, U.S. 62/182,514 filed Jun. 20, 2015, US 62/274,313 filed Jan. 3, 2016, and U.S. 62/275,255 filed Jan. 6, 2016, which applications are incorporated herein by reference.

### FIELD OF THE INVENTION

A mobile phone/tablet shell with finger grasping ring, which belongs to the accessories of mobile phones and tablets.

### BACKGROUND OF THE INVENTION

Now the scale of mobile phones and tablets grew and grew. While the big screen is easier to read, but the habit using the hand holding the mobile phone or tablet and the thumb of same hand operating touch-screen becomes increasingly difficult, sometimes even causes mobile phone or tablet falling to the ground to be damaged. Various existing mobile phone or tablet shells, they just have functions of protection or supporting the phone or tablet on the table, but cannot solve the above mentioned difficulty.

The purpose of the present invention is to provide a mobile phone/tablet shell with finger grasping ring for solve the above mentioned difficulty, i.e. the new mobile phone/tablet shell with finger grasping ring can help people using his hand and palm to hold phone or tablet and using the thumb of the same hand for operating the touch-screen easy and safely.

### SUMMARY OF THE INVENTION

The purpose of present invention is realized by the following conceptions:

A mobile phone/tablet shell with finger grasping ring comprises a box for receiving a body of the mobile phone or tablet, a finger grasping ring is provided on an outer surface of the box bottom, the finger grasping ring is provided a multiple of finger holes which are enterable by fingers, a turning connector connects the finger grasping ring with the outer surface of the box bottom, thereby the finger grasping ring is rotatable.

The mobile phone/tablet shell with finger grasping ring of claim 2, wherein a short flexible wire connects a side of the finger grasping ring with the box bottom near the turning connector, thereby an opening of the finger grasping ring is restricted.

The box is an elastic material, the finger grasping ring itself is a part of the box bottom, a part of surround of the finger grasping ring is divided from the box bottom and other part is still connected, the turning connector is an elastic connecting portion between the finger grasping ring and the box.

The box is a rigid material, the turning connector is a hinge.

User by using his fingers which are inserted in the finger hole of the finger grasping ring and his palm can firmly hold the mobile phone or tablet, so that his thumb of the same hand is free to operate the touch screen.

### BRIEF DESCRIPTION OF THE DRAWINGS

FIG. 1 is a perspective view of the mobile phone/tablet shell with finger grasping ring of the present invention.

FIG. 2 is a rear view of the mobile phone/tablet shell with finger grasping ring shown in the FIG. 1, the finger grasping ring is in the middle of the box bottom.

FIG. 2a shows the finger grasping ring is turned outward.

FIG. 2b shows the finger grasping ring is connected with the box bottom by a hinge.

FIG. 3 shows the box bottom has two finger grasping rings, which are closed by turning to inward and are opened by turning to outward.

FIG. 3a shows the box bottom has two finger grasping ring, which are opened by turning to inward and are closed by turning to outward.

FIG. 4 shows the box bottom has a finger grasping ring, there are two parallel rows of finger holes on the finger grasping ring.

FIG. 5 shows the finger hole on the finger grasping ring has a valve, which can be opened or closed.

FIG. 5a shows the finger grasping ring shown in FIG. 5 is turned open, and the valve of the hole is turned open too.

FIGS. 6, 6a and 6b show the finger grasping ring has various shapes and the valve of the finger hole has various shapes.

FIGS. 7 and 7a show a flexible wire connecting a side of the finger grasping ring with the box bottom, thereby the opening of the finger grasping ring is restricted.

FIGS. 8 and 8a show the usage of the mobile phone/tablet shell with finger grasping ring.

### DETAIL DESCRIPTION OF THE INVENTION

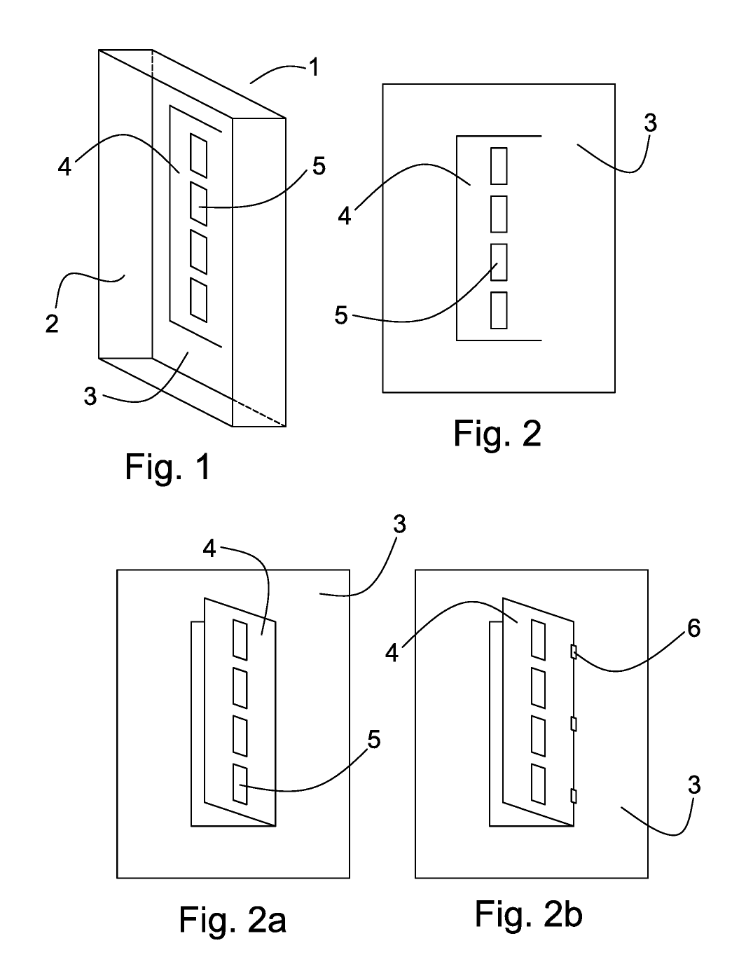

As shown in FIG. 1 the mobile phone/tablet shell with finger grasping ring is composed by a box 1 and a finger grasping ring 4, the box 1 has box sides 2 and a box bottom 3. The mobile phone or tablet is placed in the box 1 and wrapped by the box sides 2.

As shown in FIG. 2, there is a finger grasping ring 4 on the box bottom 3. The finger grasping ring 4 is a rectangular part of the box bottom 3, three sides of the rectangular part are divided from the box bottom 3 by cutting, and the other side is still connected with the box bottom 3.

The finger grasping ring 4 may be in other shapes, such as oval or half-moon.

The box bottom 3 is an elastic material, so the finger grasping ring 4 can be turned open from or turned close to the box bottom 3. The finger grasping ring 4 has a plurality of finger holes 5, which may be square, rectangular, circular, or semicircular, the number of the finger holes 5 may be one, two, three or four.

As shown by FIG. 2a, the finger grasping ring 4 has been turned open.

As shown by FIG. 2b the finger grasping ring 4 is connected with the box bottom 3 by a hinge 6. The finger grasping ring 4 is turned open, it also can be turned close.

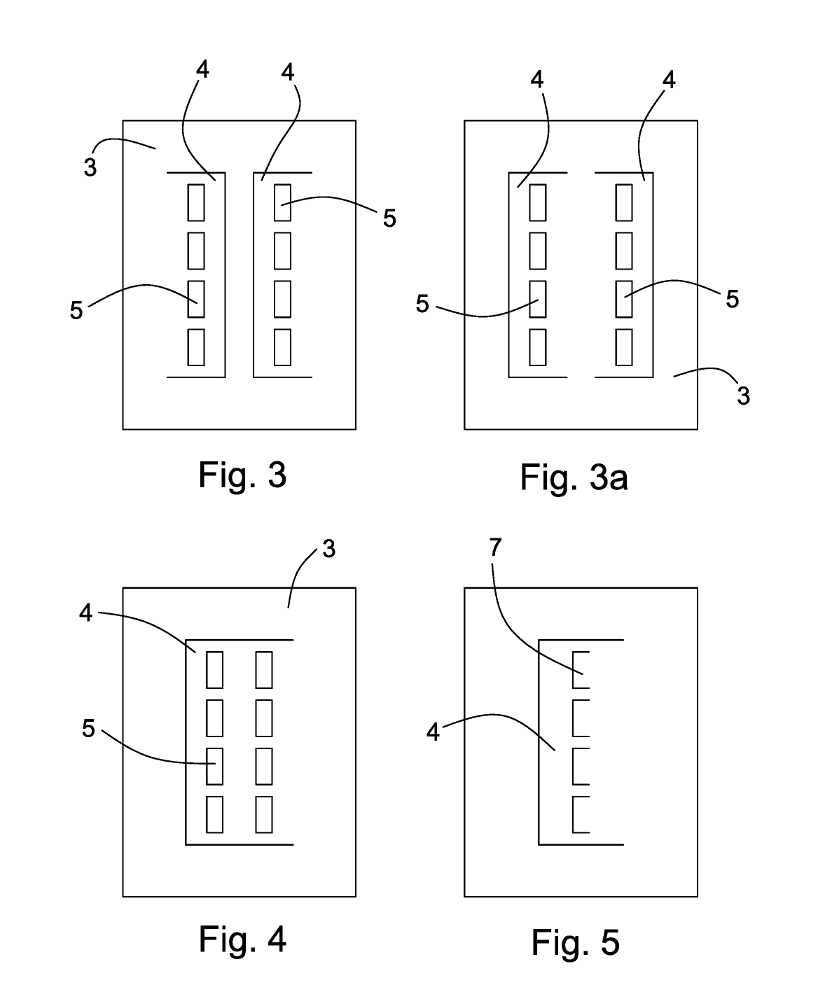

As shown by FIG. 3, there are two finger grasping rings 4 on the box bottom 3, the two finger grasping rings 4 are closed by turning to inward and are opened by turning to outward.

As shown by FIG. 3a, there are two finger grasping rings 4 on the box bottom 3, the two finger grasping rings 4 are opened by turning to inward and are closed by turning to outward.

As shown by FIG. 4, there are one finger grasping rings 4 on the box bottom 3, the multiple of finger holes 5 are arranged as two parallel rows.

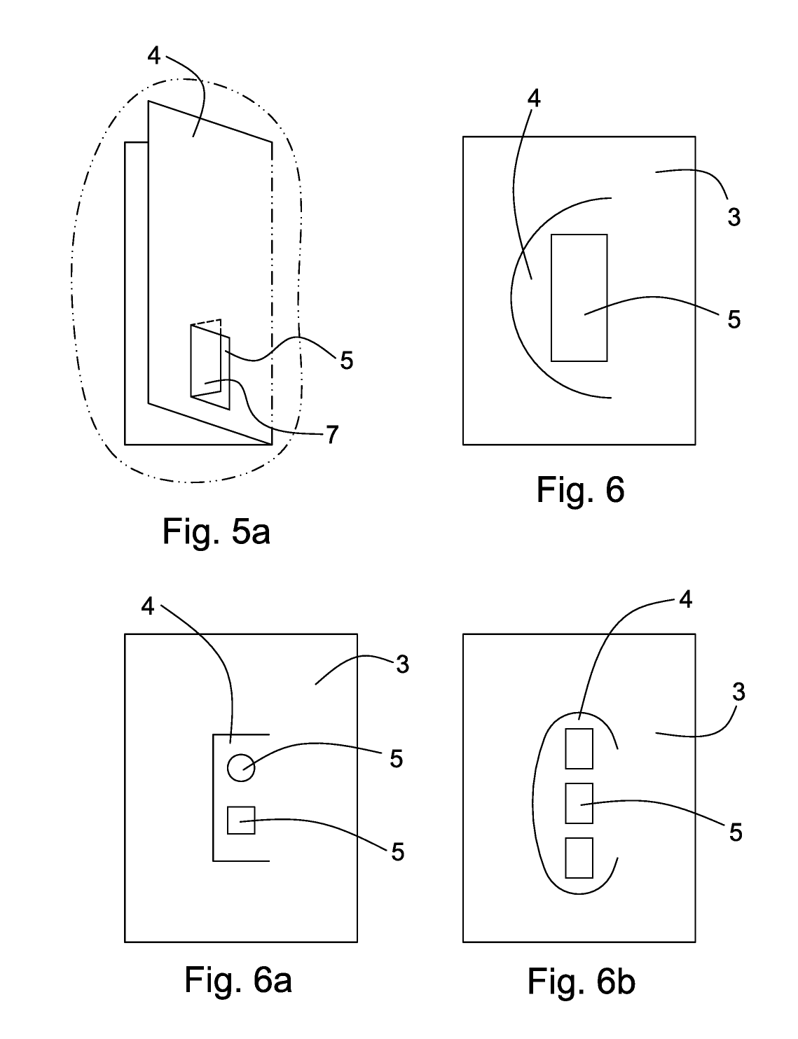

As shown in FIGS. 5 and 5a the finger hole 5 of the finger grasping ring 4 has an elastic valve 7, the valve 7 can be opened or closed.

As shown by FIGS. 6, 6a and 6b, the finger grasping ring 4 has a rectangular shape, semi-circular, or elliptical shape, the finger holes 5 of the finger grasping ring 4 are rectangular, round, or square.

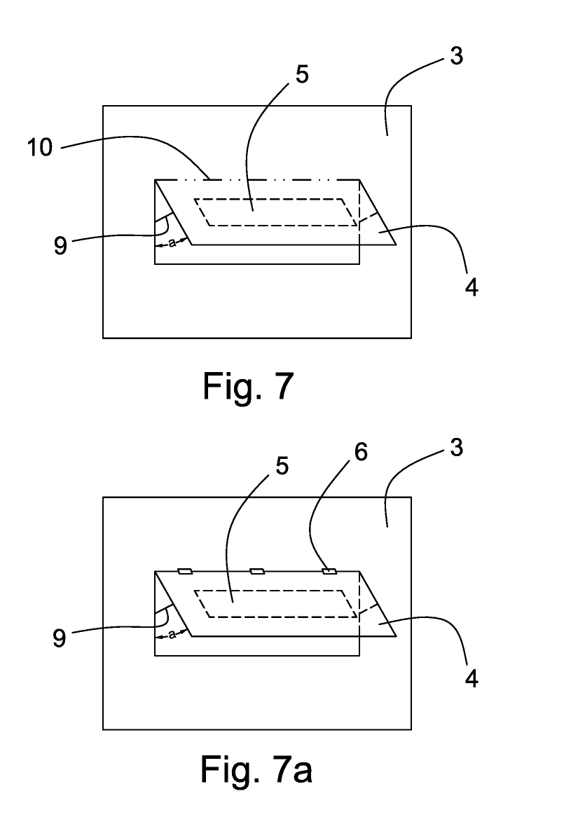

As shown by FIG. 7, a short flexible wire 9 connects a side of the finger grasping ring 4 with the box bottom 3 near the turning connector 10, thereby an opening a of the finger grasping ring 4 is restricted. There is one finger hole 5 or no finger hole 5 on the finger grasping ring 4. As the opening of the opening a of the finger grasping ring 4 is restricted, the mobile phone/tablet shell with finger grasping ring can support the mobile phone or tablet to stand on the desk, also the user can use his fingers and palm to grasp the mobile phone or tablet firmly, the thumb of the same hand can be free to operate the touch-screen.

As shown by FIG. 7a, a short flexible wire 9 connects a side of the finger grasping ring 4 with the box bottom 3 near the hinge 5, thereby an opening a of the finger grasping ring 4 is restricted. There is one finger hole 5 or no finger hole 5 on the finger grasping ring 4. As the opening of the opening a of the finger grasping ring 4 is restricted, the mobile phone/tablet shell with finger grasping ring can support the mobile phone or tablet to stand on the desk, also the user can use his fingers and palm to grasp the mobile phone or tablet firmly, the thumb of the same hand can be free to operate the touch-screen.

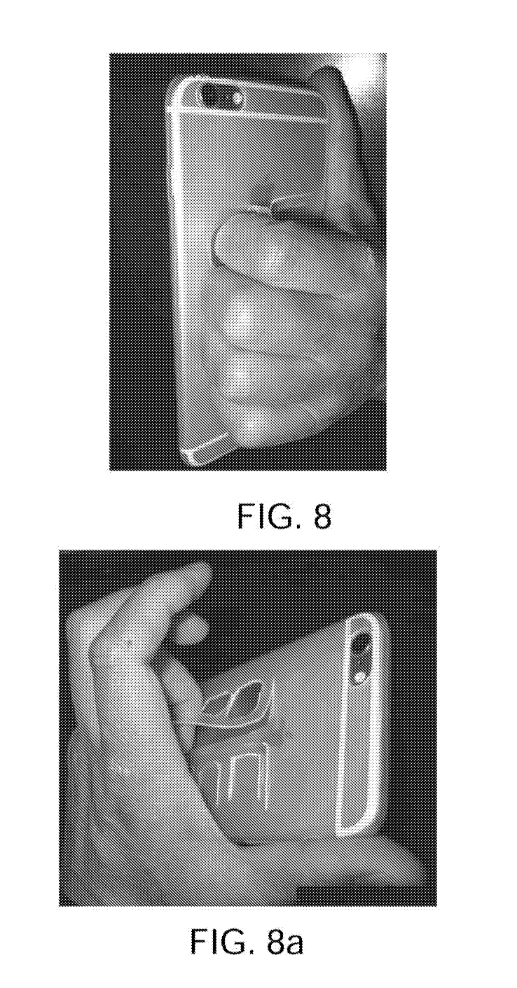

The FIGS. 8 and 8a, show the usage of the mobile phone/tablet shell with finger grasping ring. User uses his fingers and palm to grasp the mobile phone or tablet firmly, the thumb of the same hand can be free to operate the touch-screen.

Because of the valves 7 of the finger holes 5 can be closed, so that the mobile phone or tablet can be better protected and will not be scratched.

What is claimed is:

1. A mobile phone/tablet shell with finger grasping ring comprising:
a box for receiving a body of the mobile phone or tablet, wherein
a finger grasping ring provided on a box bottom of the box;
the finger grasping ring is provided with a multiple of finger holes, which are enterable by fingers;
a turning connector connecting the finger grasping ring to the box bottom, thereby the finger grasping ring is rotatable.

2. The mobile phone/tablet shell with finger grasping ring of claim 1, wherein the box is an elastic material, the finger grasping ring itself is a part of the box bottom, a part of surround of the finger grasping ring is divided from the box bottom and other part is still connected, the turning connector is an elastic connecting portion between the finger grasping ring and the box bottom.

3. The mobile phone/tablet shell with finger grasping ring of claim 1, wherein the finger grasping ring has a multiple of finger holes, which are enterable by fingers.

4. The mobile phone/tablet shell with finger grasping ring of claim 1, wherein the multiple of finger holes have resilient finger valves.

5. The mobile phone/tablet shell with finger grasping ring of claim 3, wherein the finger grasping ring is rectangular, three sides of the finger grasping ring are separated from the box bottom and one side is still connected with the box bottom, thereby the rectangular finger grasping ring is rotatable.

6. The mobile phone/tablet shell with finger grasping ring of claim 5, wherein there are two finger grasping rings on the box bottom, the two finger grasping rings are closed by turning to inward and are opened by turning to outward.

7. The mobile phone/tablet shell with finger grasping ring of claim 5, wherein there are two finger grasping rings on the box bottom, the two finger grasping rings are opened by turning to inward and are closed by turning to outward.

8. The mobile phone/tablet shell with finger grasping ring of claim 3, wherein the finger grasping ring has a multiple of finger holes which are enterable by fingers, the multiple of finger holes are arranged as two parallel rows.

9. The mobile phone/tablet shell with finger grasping ring of claim 1, wherein the box is a rigid material, the turning connector is a hinge.

10. The mobile phone/tablet shell with finger grasping ring of claim 9, wherein the finger grasping ring has a multiple of finger holes, which are enterable by fingers.

11. The mobile phone/tablet shell with finger grasping ring of claim 9, wherein the finger grasping ring is rectangular.

12. The mobile phone/tablet shell with finger grasping ring of claim 11, wherein there are two finger grasping rings on the box bottom, the two finger grasping rings are closed by turning to inward and are opened by turning to outward.

13. The mobile phone/tablet shell with finger grasping ring of claim 11, wherein there are two finger grasping rings on the box bottom, the two finger grasping rings are opened by turning to inward and are closed by turning to outward.

14. The mobile phone/tablet shell with finger grasping ring of claim 1, wherein the multiple of finger holes on the finger grasping ring are square, rectangular, semi-circular, or circular.

15. The mobile phone/tablet shell with finger grasping ring of claim 1, wherein there are one, two, three or four finger holes on the finger grasping ring.

16. The mobile phone/tablet shell with finger grasping ring of claim 2, wherein a short flexible wire connects a side of the finger grasping ring with the box bottom near the turning connector, thereby an opening of the finger grasping ring is restricted.

17. The mobile phone/tablet shell with finger grasping ring of claim 11, wherein a short flexible wire connects a side of the finger grasping ring with the box bottom near the hinge, thereby an opening of the finger grasping ring is restricted.
